(19) United States
(12) Patent Application Publication
(10) Pub. No.: US 2026/0180709 A1
(43) Pub. Date: Jun. 25, 2026

(54) COMMUNICATION SYSTEMS, APPARATUSES, METHODS, AND NON-TRANSITORY COMPUTER-READABLE STORAGE DEVICES EMPLOYING STREAM-BASED MODULATION AND CODING SYSTEM ALLOCATION FOR MULTIPLE-INPUT MULTIPLE-OUTPUT COMMUNICATIONS

(71) Applicant: Huawei Technologies Co., Ltd., Shenzhen (CN)

(72) Inventors: Jung Hoon Suh, Ottawa (CA); Yan Xin, Ottawa (CA); Osama Aboul-Magd, Ottawa (CA); Kwok Shum Au, Ottawa (CA)

(21) Appl. No.: 19/541,226

(22) Filed: Feb. 16, 2026

Related U.S. Application Data
(63) Continuation of application No. PCT/CN2023/123325, filed on Oct. 8, 2023.
(60) Provisional application No. 63/533,188, filed on Aug. 17, 2023.

(51) Int. Cl. H04L 1/00; H04B 7/0452; H04L 27/26

(52) U.S. Cl. CPC H04L 1/0003; H04B 7/0452; H04L 27/2603

(57) ABSTRACT

A first method has the steps of: generating a signaling for one or more devices, and transmitting the signaling to the one or more devices; for each of the one or more devices, the signaling is for indicating a plurality of streams allocated to the device and a plurality of modulation and coding system (MCS) indices each corresponding to one of the streams. Accordingly, a second method has the steps of receiving a signaling from a device to obtain a plurality of streams and a plurality of MCS indices corresponding to the streams, and transmitting signals to the device using the streams with parameters of each stream defined by the corresponding MCS index. In some embodiments, the signaling is carried in a trigger frame for uplink MIMO communication, or in a physical layer protocol data unit for downlink MIMO communication.

### CROSS-REFERENCE TO RELATED APPLICATIONS

This application is a continuation of International Application No. PCT/CN2023/123325, filed on Oct. 8, 2023, which claims the benefit of U.S. Provisional Patent Application Ser. No. 63/533,188, filed Aug. 17, 2023. The disclosures of the aforementioned applications are hereby incorporated by reference in their entireties.

### TECHNICAL FIELD

The present disclosure relates generally to communication systems, apparatuses, methods, and non-transitory computer-readable storage devices, and in particular to communication systems, apparatuses, methods, and non-transitory computer-readable storage devices employing stream-based modulation and coding system allocation for multiple-input multiple-output (MIMO) communications such as uplink multi-user MIMO communications.

### BACKGROUND

In wireless communication systems such as 802.11ac (WI-FI® 5; WI-FI is a registered trademark of Wi-Fi Alliance, Austin, TX, USA) and 802.11ax (WI-FI® 6) systems, multiple-input multiple-output (MIMO) technologies may be used which leverage multiple antennas on the access point (AP) and/or stations (STAs) to form a plurality of spatial streams (or simply “streams”) between the AP and STAs for communication therebetween.

In such systems, the modulation and coding system (MCS; also called “the modulation and coding scheme”) defines a plurality of candidate MCS indices (wherein the ensemble thereof is denoted a MCS table) wherein each MCS index represents a set of modulation and coding parameters such as the modulation type, the coding rate, the number of streams, the channel width, and the orthogonal frequency division multiplexing (OFDM) guard interval, and the like. Thus, different MCS indices represents different communication performances. The AP and STAs may negotiate the MCS indices to be used for establishing communications therebetween.

For uplink (UL) communications from STAs to the AP, UL multi-user multiple-input multiple-output (MU-MIMO) technology may be used to allow multiple STAs to simultaneously transmit signals to the AP using a plurality of streams. In prior art, a STA may be assigned with one MCS index regardless how many streams are allocated to the STA. Therefore, the communication performance of a STA may be severely deteriorated if a low-performance MCS index is allocated thereto.

### SUMMARY

According to one aspect of this disclosure, there is provided a first multiple-input multiple-output (MIMO) communication method comprising: generating a signaling for one or more devices; and transmitting the signaling to the one or more devices; for each of the one or more devices, the signaling is for indicating a plurality of streams allocated to the device and a plurality of modulation and coding system (MCS) indices each corresponding to one of the plurality of streams.

In some embodiments of the first MIMO communication method, the one or more devices are one or more stations (STAs).

In some embodiments of the first MIMO communication method, the signaling comprises a first indication and a second indication for each of one or more devices; and for each of the one or more devices, the first indication is for indicating a plurality of streams allocated to the device, and the second indication is for indicating a plurality of modulation and coding system (MCS) indices each corresponding to one of the plurality of streams.

In some embodiments of the first MIMO communication method, the signaling is carried in a trigger frame for uplink (UL) MIMO communication; the trigger frame comprises a user information field for each device; and the first and second indications for each device are stored in the corresponding user information field of the trigger frame.

In some embodiments of the first MIMO communication method, the signaling is carried in a trigger frame for uplink (UL) multi-user MIMO (MU-MIMO) communication or for UL single-user MIMO (SU-MIMO) communication.

In some embodiments of the first MIMO communication method, the first indication also indicates a MCS table comprising a plurality of MCS sets, each MCS set comprising a plurality of items representing a plurality of candidate MCS indices for the plurality of streams, and the second indication comprises a MCS set index for indicating one MCS set of the plurality of MCS sets.

In some embodiments of the first MIMO communication method, the MCS table is one of a plurality of candidate MCS tables; the plurality of candidate MCS tables comprise a single-stream MCS table; and each MCS set of the single-stream MCS table comprises a respective MCS index excluding a MCS index of a Dup mode.

In some embodiments of the first MIMO communication method, the plurality of candidate MCS indices of each MCS set are in non-ascending or descending order with indices of the plurality of streams increasing.

In some embodiments of the first MIMO communication method, the plurality of items of each MCS set are the plurality of candidate MCS indices of the MCS set; the plurality of items of each MCS set comprises a base candidate MCS index and one or more index differences from the base candidate MCS index; or the plurality of items of each MCS set comprises a base candidate MCS index and one or more index differences from a neighboring candidate MCS index thereof.

In some embodiments of the first MIMO communication method, the second indication comprises the plurality of candidate MCS indices.

In some embodiments of the first MIMO communication method, the first and second indications for each device are stored with a unique identifier (ID) in the user information field of the trigger frame.

In some embodiments of the first MIMO communication method, the first indication is stored in a spatial stream (SS) allocation/RA-RU information subfield of the user information field, and the second indication is stored in one or more of a UL MCS subfield, a first reserved subfield, a second reserved subfield, and a trigger dependent user information subfield of the user information field.

In some embodiments of the first MIMO communication method, the first indication is stored in the last two bits of the SS allocation/RA-RU information subfield of the user information field, and the second indication is stored in the UL MCS subfield of the user information field.

In some embodiments of the first MIMO communication method, the signaling is carried in a physical layer protocol data unit (PPDU) for downlink (DL) MIMO communication; and the first and second indications for each device are stored in one or more signal (SIG) fields of the PPDU.

In some embodiments of the first MIMO communication method, the one or more SIG fields of the PPDU comprise one or more of a L-SIG field, a RL-SIG field, a U-SIG field, and an EHT-SIG field.

In some embodiments of the first MIMO communication method, the one or more SIG fields of the PPDU comprise an EHT-SIG field; and the first and second indications for each device are stored in one or more user-specific fields of the EHT-SIG field for DL MU-MIMO, or in one or more common fields of the EHT-SIG field for DL SU-MIMO.

According to one aspect of this disclosure, there is provided one or more circuits, such as at least one processing unit or at least one processor, for performing for performing above-described first MIMO communication method.

According to one aspect of this disclosure, there is provided one or more non-transitory computer-readable storage devices comprising computer-executable instructions, wherein the instructions, when executed, cause one or more circuits, such as at least one processing unit or at least one processor, to perform above-described first MIMO communication method.

According to one aspect of this disclosure, there is provided a second MIMO communication method comprising: receiving a signaling from a device to obtain a plurality of streams and a plurality of MCS indices corresponding to the plurality of streams; and transmitting a plurality of signals to the device using the plurality of streams with parameters of each stream defined by the corresponding one of the plurality of MCS indices.

In some embodiments of the second MIMO communication method, the MIMO communication method is performed by a STA.

In some embodiments, the device is an access point (AP).

In some embodiments of the second MIMO communication method, the signaling comprises a first indication for indicating the plurality of streams, and a second indication for indicating the plurality of MCS indices.

In some embodiments of the second MIMO communication method, the signaling is carried in a trigger frame for UL MIMO communication; and the first and second indications are stored in a user information field of the trigger frame.

In some embodiments of the second MIMO communication method, the signaling is carried in a trigger frame for UL MU-MIMO communication or for UL SU-MIMO communication.

In some embodiments of the second MIMO communication method, the first indication also indicates a MCS table comprising a plurality of MCS sets, each MCS set comprising a plurality of items representing a plurality of candidate MCS indices for the plurality of streams, and the second indication comprises a MCS set index for indicating one MCS set of the plurality of MCS sets.

In some embodiments of the second MIMO communication method, the MCS table is one of a plurality of candidate MCS tables; the plurality of candidate MCS tables comprise a single-stream MCS table; and each MCS set of the single-stream MCS table comprises a respective MCS index excluding a MCS index of a Dup mode.

In some embodiments of the second MIMO communication method, the plurality of candidate MCS indices of each MCS set are in non-ascending or descending order with indices of the plurality of streams increasing.

In some embodiments of the second MIMO communication method, the plurality of items of each MCS set are the plurality of candidate MCS indices of the MCS set; the plurality of items of each MCS set comprises a base candidate MCS index and one or more index differences from the base candidate MCS index; or the plurality of items of each MCS set comprises a base candidate MCS index and one or more index differences from a neighboring candidate MCS index thereof.

In some embodiments of the second MIMO communication method, the second indication comprises the plurality of candidate MCS indices.

In some embodiments of the second MIMO communication method, the first and second indications for each device are stored with a unique ID in the user information field of the trigger frame.

In some embodiments of the second MIMO communication method, the first indication is stored in a SS allocation/RA-RU information subfield of the user information field, and the second indication is stored in one or more of a UL MCS subfield, a first reserved subfield, a second reserved subfield, and a trigger dependent user information subfield of the user information field.

In some embodiments of the second MIMO communication method, the first indication is stored in the last two bits of the SS allocation/RA-RU information subfield of the user information field, and the second indication is stored in the UL MCS subfield of the user information field.

In some embodiments of the second MIMO communication method, the signaling is carried in a PPDU for DL MIMO communication; and the first and second indications are stored in one or more SIG fields of the PPDU.

In some embodiments of the second MIMO communication method, the one or more SIG fields of the PPDU comprise one or more of a L-SIG field, a RL-SIG field, a U-SIG field, and an EHT-SIG field.

In some embodiments of the second MIMO communication method, the one or more SIG fields of the PPDU comprise an EHT-SIG field; and the first and second indications for each device are stored in one or more user-specific fields of the EHT-SIG field for DL MU-MIMO, or in one or more common fields of the EHT-SIG field for DL SU-MIMO.

In some embodiments of the second MIMO communication method, the signal transmitted via each stream is encoded and/or interleaved independent of the signals transmitted via other streams.

According to one aspect of this disclosure, there is provided one or more circuits, such as at least one processing unit or at least one processor, for performing above-described second MIMO communication method.

According to one aspect of this disclosure, there is provided one or more non-transitory computer-readable storage devices comprising computer-executable instructions, wherein the instructions, when executed, cause one or more circuits, such as at least one processing unit or at least one processor, to perform above-described second MIMO communication method.

The above-described first and second MIMO communication methods allow APs and STAs to communicate with each other via a plurality of streams with communication parameters (represented by the MCS indices) adapting to the characteristics of the streams for better use of the streams, compared to the conventional methods wherein a STA may have to adapt the worst one of the allocated streams and waste the capacity of other, better streams. As a result, the communication performances achieved by the stream-based MCS allocation and indication methods disclosed herein is improved.

### BRIEF DESCRIPTION OF THE DRAWINGS

FIG. 1 is a simplified schematic diagram showing a communication system, according to some embodiments of this disclosure;

FIG. 2 is a simplified schematic diagram of an access point (AP) of the communication network of the communication system shown in FIG. 1;

FIG. 3 is a simplified schematic diagram of a station (STA) of the communication system shown in FIG. 1;

FIG. 4 is a schematic diagram showing uplink (UL) multiuser multiple-input multiple-output (MU-MIMO) of the communication system shown in FIG. 1;

FIG. 5 is a plot showing the packet error rate (PER) performances of UL MU-MIMO of three scheduled STAs using the prior-art MCS allocation method;

FIG. 6 is a schematic diagram showing the structure of a trigger frame transmitted from an AP to a plurality of STAs of the communication system shown in FIG. 1, according to some embodiments of this disclosure;

FIG. 7 is a schematic diagram showing the structure of a user information field of the trigger frame shown in FIG. 6, according to some embodiments of this disclosure;

FIG. 8 is a flowchart showing a notification procedure performed by an AP of the communication system shown in FIG. 1 for notifying a plurality of STAs regarding their allocated streams and corresponding MCS indices, according to some embodiments of this disclosure;

FIG. 9 is a flowchart showing a procedure performed by a STA of the communication system shown in FIG. 1 for establishing the UL communication with an AP using the allocated streams, according to some embodiments of this disclosure;

FIG. 10 is a plot showing the PER comparison between the per-stream-MCS method shown in FIGS. 8 and 9 and conventional per-STA-MCS method of UL MU-MIMO from three (3) STAs to an AP of the communication system shown in FIG. 1, wherein each STA is allocated with two streams;

FIG. 11 is a plot showing the goodput comparison between the per-stream-MCS method shown in FIGS. 8 and 9 and conventional per-STA-MCS method of UL MU-MIMO from three (3) STAs to an AP of the communication system shown in FIG. 1, wherein each STA is allocated with two streams; and

FIG. 12 is a schematic diagram showing the structure of an extremely high throughput (EHT) physical layer protocol data unit (PPDU) transmitted from an AP to a plurality of STAs of the communication system shown in FIG. 1, according to some embodiments of this disclosure.

### DETAILED DESCRIPTION

Embodiments disclosed herein relate to wireless systems, apparatuses, and methods communication systems, apparatuses, methods, and non-transitory computer-readable storage devices employing stream-based modulation and coding system allocation for uplink multi-user multiple-input multiple-output (MU-MIMO) communications. The wireless systems, apparatuses, and methods disclosed herein may be any suitable systems, apparatuses, and methods for transmitting wireless signals. Examples of such systems may be WI-FI® systems, 5G or 6G wireless mobile communication systems, and the like.

### A. SYSTEM STRUCTURE

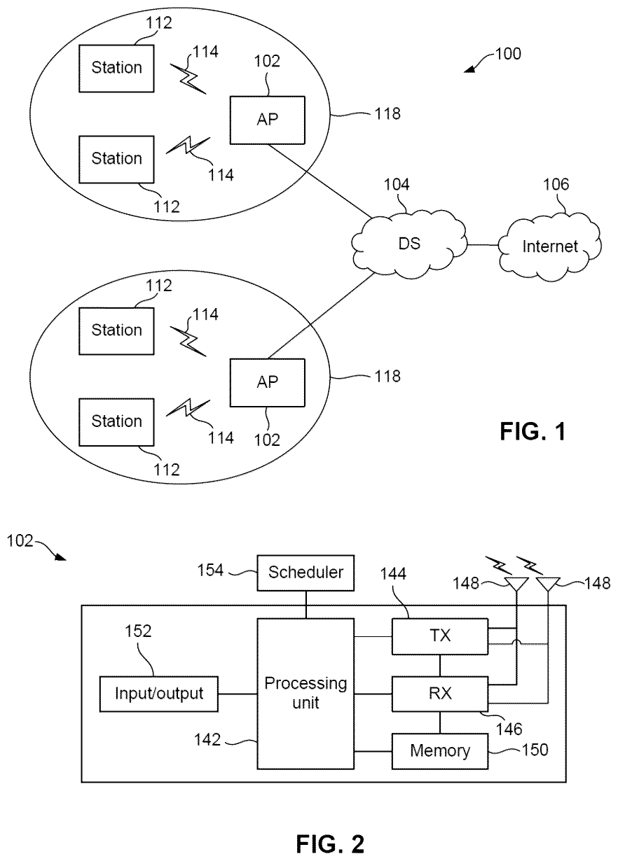

Turning now to FIG. 1, a communication system according to some embodiments of this disclosure is shown and is generally identified using reference numeral 100. As an example, the communication system 100 may be a WI-FI® system built under relevant standards such as IEEE 802.11 standard. As shown, the communication system 100 comprises a plurality of interconnected networking devices 102 such as a plurality of interconnected access points (APs; also called “base stations”) forming a distribution system (DS) 104 which is in turn connected to other networks such as the Internet 108 which may include a network of computers and subnets (intranets) or both, and incorporate protocols, such as Internet Protocol (IP), Transmission Control Protocol (TCP), User Datagram Protocol (UDP), and/or the like.

Each AP 102 is in wireless communication with one or more mobile or stationary stations 112 (STAs) through respective wireless channels 114 for providing wireless network connects thereto. Herein, the APs 102 and STAs 112 may be considered as different types of network nodes (or simply “nodes”) of the communication system 100. Each AP 102 and the STAs 112 connected thereto form a cell or basic service set (BSS) 118.

FIG. 2 is a simplified schematic diagram of an AP 102. As shown, the AP 102 comprises at least one processing unit 142 (also denoted at least one “processor”), at least one transmitter (TX) 144, at least one receiver (RX) 146 (collectively referred to as a transceiver), one or more antennas 148, at least one memory 150, and one or more input/output components or interfaces 152. A scheduler 154 may be coupled to the processing unit 142. The scheduler 154 may be included within or operated separately from the AP 102. Each of these components 142 to 154 may be implemented as one or more circuits (such as one or more electronic circuits and/or one or more optical circuits). Alternatively, the ensemble of these components 142 to 154 may be implemented as one or more circuits.

The processing unit 142 is configured for performing various processing operations such as signal coding, data processing, power control, input/output processing, or any other suitable functionalities. The processing unit 142 may comprise a microprocessor, a microcontroller, a digital signal processor, a FPGA, an ASIC, and/or the like. In some embodiments, the processing unit 142 may execute computer-executable instructions or code stored in the memory 150 to perform various the procedures (otherwise referred to as methods) described below.

Each transmitter 144 may comprise any suitable structure for generating signals, such as control signals as described in detail below, for wireless transmission to one or more STAs 112. Each receiver 146 may comprise any suitable structure for processing signals received wirelessly from one or more STAs 112. Although shown as separate components, at least one transmitter 144 and at least one receiver 146 may be integrated and implemented as a transceiver. Each antenna 148 may comprise any suitable structure for transmitting and/or receiving wireless signals. Although common antennas 148 are shown in FIG. 2 as being coupled to both the transmitter 144 and the receiver 146, one or more antennas 148 may be coupled to the transmitter 144, and one or more other antennas 148 may be coupled to the receiver 146.

In some embodiments, an AP 102 may comprise a plurality of transmitters 144 and receivers 146 (or a plurality of transceivers) together with a plurality of antennas 148 for communication in its cell 118.

Each memory 150 may comprise any suitable volatile and/or non-volatile storage such as RAM, ROM, hard disk, optical disc, SIM card, solid-state memory, memory stick, SD memory card, and/or the like. The memory 150 may be used for storing instructions executable by the processing unit 142 and data used, generated, or collected by the processing unit 142. For example, the memory 150 may store instructions of software, software systems, or software modules that are executable by the processing unit 142 for implementing some or all of the functionalities and/or embodiments of the procedures performed by an AP 102 described herein.

Each input/output component 152 enables interaction with a user or other devices in the communication system 100. Each input/output device 152 may comprise any suitable structure for providing information to or receiving information from a user and may be, for example, a speaker, a microphone, a keypad, a keyboard, a display, a touch screen, a network communication interface, and/or the like.

Herein, the STAs 112 may be any suitable wireless device that may join the communication system 100 via an AP 102 for wireless operation. In various embodiments, a STA 112 may be a wireless electronic device used by a human or user (such as a smartphone, a cellphone, a personal digital assistant (PDA), a laptop, a desktop computer, a tablet, a smart watch, a consumer electronics device, and/or the like). A STA 112 may alternatively be a wireless sensor, an Internet-of-things (IoT) device, a robot, a shopping cart, a vehicle, a smart TV, a smart appliance, a wireless transmit/receive unit (WTRU), a mobile station, or the like. Depending on the implementation, the STA 112 may be movable autonomously or under the direct or remote control of a human, or may be positioned at a fixed position.

In some embodiments, a STA 112 may be a multimode wireless electronic device capable of operation according to multiple radio access technologies and incorporate multiple transceivers necessary to support such.

In addition, some or all of the STAs 112 comprise functionality for communicating with different wireless devices and/or wireless networks via different wireless links using different wireless technologies and/or protocols. Instead of wireless communication (or in addition thereto), the STAs 112 may communicate via wired communication channels to other devices or switches (not shown), and to the Internet 106. For example, a plurality of STAs 112 (such as STAs 112 in proximity with each other) may communicate with each other directly via suitable wired or wireless sidelinks.

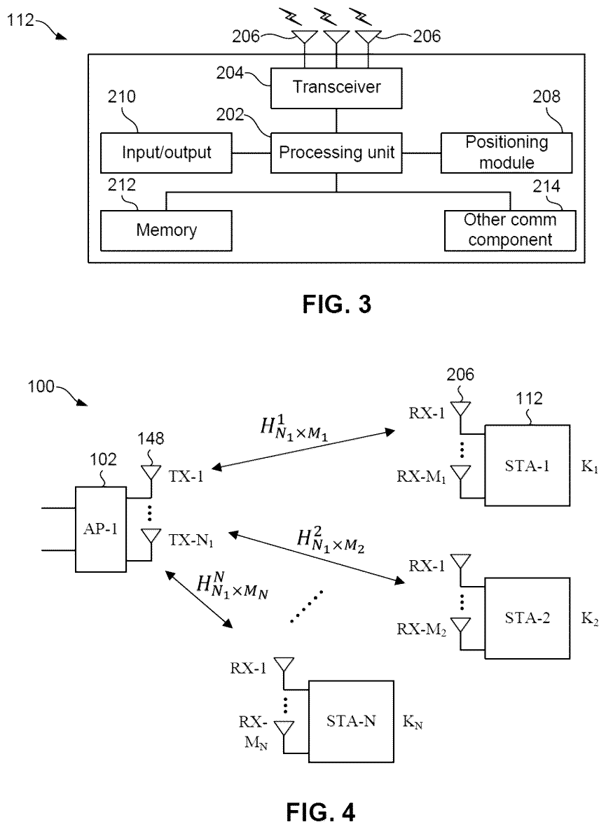

FIG. 3 is a simplified schematic diagram of a STA 112. As shown, the STA 112 comprises at least one processing unit 202, at least one transceiver 204, at least one antenna or network interface controller (NIC) 206, at least one positioning module 208, one or more input/output components 210, at least one memory 212, and at least one other communication component 214. Each of these components 202 to 214 may be implemented as one or more circuits (such as one or more electronic circuits and/or one or more optical circuits). Alternatively, the ensemble of these components 202 to 214 may be implemented as one or more circuits.

The processing unit 202 is configured for performing various processing operations such as signal coding, data processing, power control, input/output processing, or any other functionalities to enable the STA 112 to access and join the communication system 100 and operate therein. The processing unit 202 may also be configured to implement some or all of the functionalities of the STA 112 described in this disclosure. The processing unit 202 may comprise a central processing unit (CPU), a microprocessor, a microcontroller, a digital signal processor, an accelerator, a graphic processing unit (GPU), a tensor processing unit (TPU), a FPGA, or an ASIC. Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like. In some embodiments, the processing unit 202 may execute computer-executable instructions or code stored in the memory 212 to perform various processes described below.

The at least one transceiver 204 may be configured for modulating data or other content for transmission by the at least one antenna 206 to communicate with an AP 102. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The positioning module 208 is configured for communicating with a plurality of global or regional positioning devices such as navigation satellites for determining the location of the STA 112. The navigation satellites may be satellites of a global navigation satellite system (GNSS) such as the Global Positioning System (GPS) of USA, Global'naya Navigatsionnaya Sputnikovaya Sistema (GLONASS) of Russia, the Galileo positioning system of the European Union, and/or the Beidou system of China. The navigation satellites may also be satellites of a regional navigation satellite system (RNSS) such as the Indian Regional Navigation Satellite System (IRNSS) of India, the Quasi-Zenith Satellite System (QZSS) of Japan, or the like. In some other embodiments, the positioning module 208 may be configured for communicating with a plurality of indoor positioning device for determining the location of the STA 112.

The one or more input/output components 210 is configured for interaction with a user or other devices in the communication system 100. Each input/output component 210 may comprise any suitable structure for providing information to or receiving information from a user and may be, for example, a speaker, a microphone, a keypad, a keyboard, a display, a touch screen, and/or the like.

The at least one memory 212 is configured for storing instructions executable by the processing unit 202 and data used, generated, or collected by the processing unit 202. For example, the memory 212 may store instructions of software, software systems, or software modules that are executable by the processing unit 202 for implementing some or all of the functionalities and/or embodiments of the STA 112 described herein. Each memory 212 may comprise any suitable volatile and/or non-volatile storage and retrieval components such as RAM, ROM, hard disk, optical disc, SIM card, solid-state memory modules, memory stick, SD memory card, and/or the like.

The at least one other communication component 214 is configured for communicating with other devices such as other STAs 112 via other communication means such as a radio link, a BLUETOOTH® link (BLUETOOTH is a registered trademark of Bluetooth Sig Inc., Kirkland, WA, USA), a wired sidelink, and/or the like. Examples of the wired sidelink may be a USB cable, a network cable, a parallel cable, a serial cable, and/or the like.

In some embodiments, a STA 112 may comprise a plurality of transceivers 204 and a plurality of antennas 206 for communication with an AP 102.

In the communication between the AP 102 and the STA 112, a transmission from the STA 112 to the AP 102 is usually denoted an uplink (UL) and the wireless channel used therefor is denoted an uplink channel. A transmission from the AP 102 to the STA 112 is usually denoted a downlink (DL) and the wireless channel used therefor is denoted a downlink channel. Suitable modulation technologies may be used for communication between the AP 102 and the STA 112. For example, in some embodiments, orthogonal frequency-division multiplexing (OFDM) may be used wherein the channel 114 is partitioned into a plurality orthogonal subchannels for communication between the AP 102 and the STA 112. Moreover, as there are usually a plurality of STAs 112 in communication with a same AP 102, suitable multiple-access technologies may be used. For example, in some embodiments, orthogonal frequency-division multiple access (OFDMA) may be used for communication between the AP 102 and STAs 112.

### B. MCS ALLOCATION AND INDICATION

With the use of a plurality of antennas at the AP side and/or at the STA side, the AP 102 and the STA 112 may use multiple-input multiple-output (MIMO) technologies for communication therebetween, wherein such a system 100 may be denoted a “MIMO system”. More specifically, MIMO technologies may be used for communication between an AP 102 and a single STA 112 (denoted “SU-MIMO”) or between an AP 102 and a plurality of STAs 112 (denoted “MU-MIMO”). Moreover, SU-MIMO may be further classified as DL SU-MIMO (for DL communication, that is, an AP 102 transmitting signals to a single STA 112) and UL SU-MIMO (for UL communication, that is, a single STA 112 transmitting signals to an AP 102). Similarly, MU-MIMO may be further classified as DL MU-MIMO (for DL communication, that is, an AP 102 transmitting signals to a plurality of STAs 112) and UL MU-MIMO (for UL communication, that is, a plurality of STAs 112 simultaneously transmitting signals to an AP 102). For example, in the 802.11ax standard (WI-FI® 6), UL MU-MIMO may be used.

FIG. 4 is a schematic diagram showing an example of a communication system 100 using UL MU-MIMO. For ease of illustration, FIG. 4 only shows one AP 102 (also denoted “AP-1”) and N STAs 112 (also denoted “STA-1”, “STA-2”, . . . , “STA-N”). The AP 102 comprises N₁ antennas 148 (denoted “TX antennas TX-1 to TX-N₁” although they may also receive signals in UL communications), the n-th STA (STA-n) comprises Mₙ antennas 206 (denoted “RX antennas RX-1 to RX-Mₙ” although they may also transmit signals in UL communications).

In this example, the AP 102 may typically have up to 8 TX antennas 148, but each STA 112 is limited by the number of RX antennas 206. Multiple STAs 112 may transmit their UL data packets simultaneously via different spatial streams (or simply “streams”) through the wireless channel, which is called an UL MU-MIMO.

As STA-n has Mₙ RX antennas 206, the maximum number Kₙ of the streams for the UL data packet transmission from STA-n to the AP 102 is less than or equal to Mₙ. As the number of TX antennas 148 at AP-1 is N₁, the overall total streams (that is, the sum from K₁ to K_{N}) is less than or equal to N₁.

The eigenvalues of the UL streams (represented by the singular values of the diagonal matrix after singular value decomposition (SVD) of the channel matrix) are in a descending order from the first stream (corresponding to the top singular value of the diagonal matrix) to the last stream (corresponding to the bottom singular value of the diagonal matrix) (similar to the DL MIMO channel). The first K₁ streams counting from the first stream out of the overall total streams Σₙ₌₁^{N}Kₙ in the UL MU-MIMO transmission are allocated to SAT-1, the next K₂ streams counting from the (K₁+1)-th stream are allocated to STA-2, . . . and the last K_{N} streams out of the overall total streams Σₙ₌₁^{N}Kₙ in the UL MU-MIMO transmission are allocated to STA-N. Then, the eigenvalues of these streams detected at the AP side after the MIMO detection are in a descending order from the first stream to the (K_{N})-th stream.

In prior art, the same MCS may be allocated at each UL MU-MIMO scheduled STA regardless of the number of allocated streams of each scheduled STA. Thus, the worst MCS across the allocated streams in each scheduled STA would be assigned to all the allocated streams of the scheduled STA. This may spoil the average packet error rate (PER) performance of each scheduled STA.

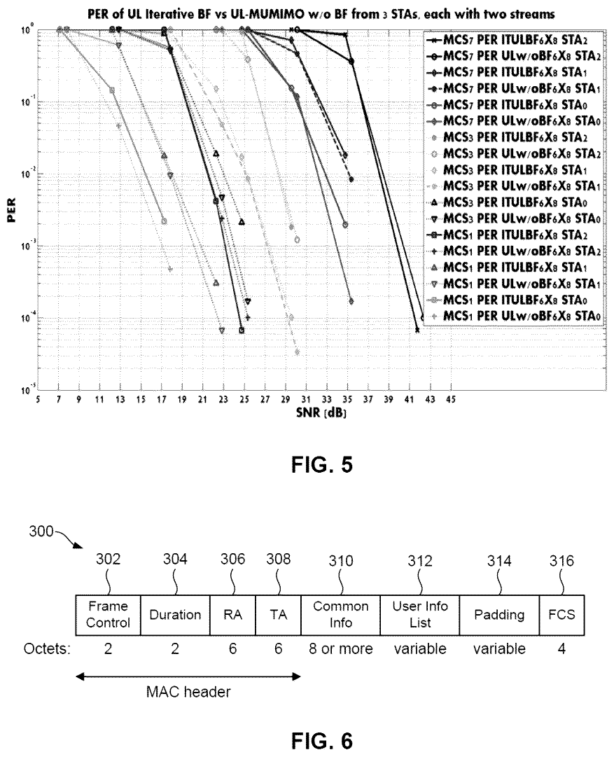

FIG. 5 is a plot showing the PER performance of UL iterative beamforming and UL MU-MIMO without UL beamforming of three scheduled STAs 112 (STA₀, STA₁, and STA₂) using the prior-art MCS allocation method, wherein each STA 112 is allocated with two streams. In the legend of FIG. 5, “ITULBF” refers to UL iterative beamforming, “ULw/oBF” refers UL MU-MIMO without UL beamforming, and “pXq” refers to p TX antennas and q RX antennas (for example, 6×8 refers to 6 TX antennas and 8 RX antennas).

As shown, for each MCS (MCS₁, MCS₃, or MCS₇), STA, shows the best performance followed by STA₁ and STA₂. When two streams in each STA are averaged, these three STAs are still showing the SNR gap for the same PER, where STA, is allocated to the first two streams, STA₁ is allocated to the next two streams and STA₂ is allocated to the last two streams. The SNR range for the same PER is the best for STA₀, followed by STA₁ and STA₂.

In some embodiments, the communication system 100 may use a stream-based MCS allocation method to allocate a MCS index to each UL stream of each UL-scheduled STA 112. Therefore, a STA 112 allocated with a plurality of UL streams may be allocated with a plurality of MCS indices, wherein the allocated MCS indices may have different index values, or some of the allocated MCS indices may have same index value. Such a stream-based MCS allocation method may significantly reduce the possibility of deteriorated communication performance of a STA due to “bad” MCS allocation.

In the following, various embodiments are described, wherein suitable signaling methods may be used for indicating the different MCS indices allocated to different streams of each scheduled STA 112. Herein, the term “signaling” refers to the use of specific signals for controlling communications, while the term “signal” generally refers to the information transmitted between devices such as between AP 102 and one or more STAs 112.

More specifically, a signaling may be transmitted from a first device (such as an AP 102) to one or more second devices (such as one or more STAs 112) for indicating the different MCS indices allocated to different streams of the scheduled STAs 112. Each STA 112 receives the signaling transmitted from the AP 102 to obtain a plurality of allocated streams and a plurality of MCS indices corresponding to the plurality of allocated streams, and then transmits a plurality of signals to the device using the plurality of allocated streams with parameters of each allocated stream defined by the corresponding MCS index.

In some embodiments, the signaling may be carried in a trigger frame for UL MIMO communication such as UL MU-MIMO and/or UL SU-MIMO. In some embodiments, the signaling may be carried in a physical layer protocol data unit (PPDU) for DL MIMO communication such as DL MU-MIMO and/or DL SU-MIMO.

The MCS allocation and indication methods disclosed herein may be used in a variety of systems such as WI-FI® 8 while providing backward-compatibility to “old” standards such as WI-FIR 6 (IEEE 802.11ax, also denoted “high efficiency (HE)”) and WI-FI® 7 (IEEE 802.11be, also denoted “extremely high throughput (EHT)”).

As those skilled in the art understand, in WI-FI® systems, an AP 102 may transmit trigger frames to STAS 112 for notify information (such as the scheduling information) to STAS 112 or request information therefrom. In prior art such as WI-FI® 6 and WI-FI® 7, the MCS indices allocated to the UL MU-MIMO scheduled STAs 112 are indicated in the trigger frame.

In some embodiments, the trigger frame may be used for indication of stream-based MCS allocation.

FIG. 6 shows the structure of a variant trigger frame 300 in these embodiments. As shown, the trigger frame 300 comprises:
a frame control field 302 of two (2) octets (that is, 16 bits, wherein one octet equals eight (8) bits),
a duration field 304 of two (2) octets,
a receiving STA address (RA) field 306 of six (6) octets (indicating the addresses of the STAs (denoted the “receiving STAs”) that the trigger frame 300 is sent thereto, such as a broadcast address for the receiving STAs),
a transmitting AP address (TA) field 308 of six (6) octets,
a common information field 310 of eight (8) or more octets,
a user information list field 312 of a variable length,
a padding field 314 of a variable length, and
a frame check sequence (FCS) field 316 of four (4) octets.

The ensemble of frame control field 302, duration field 304, RA field 306, and TA field 308 may be denoted the media access control (MAC) header.

The user information list field 312 comprises one or more user information fields (identified as 312′) for one or more receiving STAs 112, wherein each user information field 312′ comprises the details of a corresponding receiving STA 112.

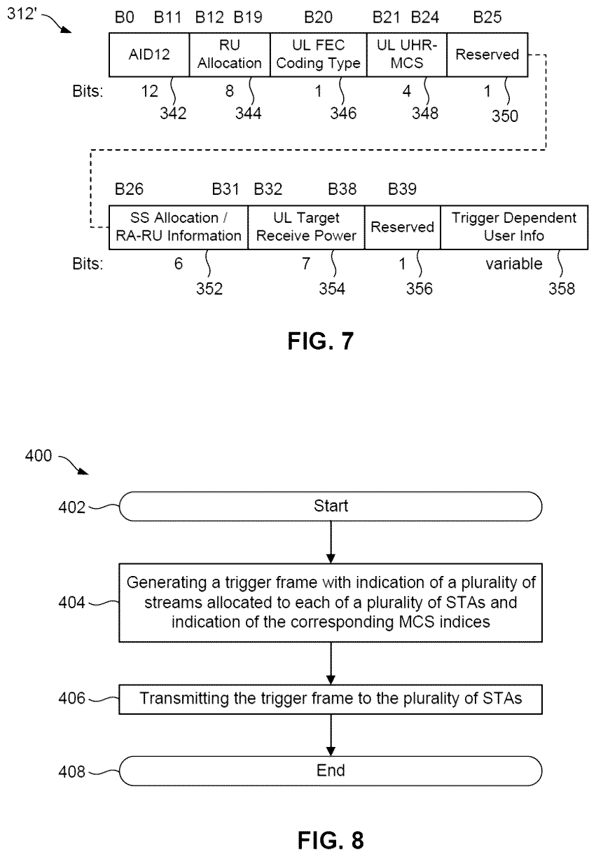

FIG. 7 shows the detail of the user information field 312′. As shown, the user information field 312′ comprises:
a 12-bit association identifier (AID) subfield 342 (from the zero-th bit (Bo) to 11-th bit (B11)) for indicating the identifier of the receiving STA,
an eight-bit resource unit (RU) allocation subfield 344 (from B12 to B19) for indicating the RU allocated to the receiving STA,
a one-bit UL forward error correction (FEC) coding type subfield 346 (B20),
a four-bit UL ultra high reliability (UHR) MCS subfield 348 (from B21 to B24),
a first one-bit reserved subfield 350 (B25) (which may be used for indicating UL dual carrier modulation (DCM)),
a six-bit spatial stream (SS) allocation/RA-RU information subfield 352 (B26-B31),
a seven-bit UL target receive power subfield 354 (such as a UL target received signal strength indicator (RSSI) subfield) (from B32 to B38),
a second one-bit reserved subfield 356 (B39), and
a variable-length trigger dependent user information subfield 358.

In prior art such as WI-FI® 6 and WI-FI® 7, the four-bit UL MCS subfield (corresponding to the UL UHR MCS subfield 348 in these embodiments) is used for indicating the MCS index assigned to the receiving STA. In HE, the six-bit SS allocation/RA-RU information subfield 352 comprises three (3) bits for indicating the number of streams allocated the receiving STA (more specifically, equal to the number of the allocated streams plus one) and three (3) bits for indicating the starting stream of the allocated streams. In EHT, the first four (4) bits of the SS allocation/RA-RU information subfield 352 are used for indicating the starting stream of the allocated streams, and the last two (2) bits are used for indicating the number of allocated streams.

In these embodiments, the four-bit UL MCS subfield 348 and six-bit SS allocation/RA-RU information subfield 352 are used for indicating one or more streams allocated to the receiving STA and the corresponding one or more MCS indices.

More specifically, in these embodiments, L MCS tables (L>1 is a predefined integer) may be predefined and are known to both the AP 102 and the STAs 112 to be scheduled for UL MU-MIMO transmission. The l-th MCS table (L≥l≥1) defines a plurality of MCS index sets (also simply denoted “MCS sets”) for l streams to be allocated to each STA 112, wherein each MCS set comprises predefined l candidate MCS indices for the l streams, and in a non-ascending order from the first one of the l streams to the last one thereof. The L MCS tables may or may not have the same number of MCS sets.

When the AP 102 allocates streams to a STA 112, the AP 102 first determines the number of streams (for example, i streams where L≥i≥1). Then, the AP 102 determines a MCS set index j from the i-th MCS table, and use the UL MCS subfield 348 and SS allocation/RA-RU information subfield 352 for sending j and i to the STA 112, respectively, wherein i indicates the number of streams allocated to the STA 112 and the corresponding MCS table, which requires log₂ L bits for storing in the trigger frame, and j indicates the MCS indices of the streams allocated to the STA 112, and requires log₂ L_{M} bits for storing in the trigger frame, where Ly is the maximum number of rows of the L MCS tables (that is, the maximum number of MCS sets among the L MCS tables).

For example in some embodiments, four (4) MCS tables may be predefined and are known to both the AP 102 and the STAs 112 (that is, L=4), including the following four MCS tables, wherein L_{M} is 15 (that is, the first MCS table has the maximum number of MCS sets among the four (4) MCS tables).

The first MCS table (Table 1) includes the base UHR MCS indices 0 to 13 and 15 excluding the Dup mode (EHT-MCS 14) for one allocated stream. The second, third, and fourth MCS tables (Tables 2 to 4) each includes 10 MCS sets, each MCS set has two, three, four MCS indices, respectively, in a non-ascending order from the first allocated stream to the last allocated stream, that is, the MCS index for the p-th allocated stream is greater than or equal to the MCS index for the q-th allocated stream if p>q. Moreover, in each MCS table, the MCS set indices may be any suitable indices, for example, starting from zero (0) but not necessarily incremental by one (1) (Table 1, wherein the MCS set index skips 14), or starting from one (1) with incremental of one (1) (Tables 2 to 4).

TABLE 1
The first MCS table for one allocated stream

| MCS set index | MCS index of the first stream |
|---|---|
| 0 | 0 |
| 1 | 1 |
| 2 | 2 |
| 3 | 3 |
| 4 | 4 |
| 5 | 5 |
| 6 | 6 |
| 7 | 7 |
| 8 | 8 |
| 9 | 9 |
| 10 | 10 |
| 11 | 11 |
| 12 | 12 |
| 13 | 13 |
| 15 | 15 |

TABLE 2
The second MCS table for two allocated streams

| | MCS index of | MCS index of |
|---|---|---|
| MCS set index | the first stream | the second stream |
| 0 | 1 | 1 |
| 1 | 3 | 1 |
| 2 | 3 | 3 |
| 3 | 5 | 1 |
| 4 | 6 | 3 |
| 5 | 7 | 3 |
| 6 | 7 | 5 |
| 7 | 7 | 7 |
| 8 | 9 | 5 |
| 9 | 9 | 7 |

TABLE 3
The third MCS table for three allocated streams

| | MCS index of | MCS index of | MCS index of |
|---|---|---|---|
| MCS set index | the first stream | the second stream | the third stream |
| 0 | 1 | 1 | 1 |
| 1 | 3 | 3 | 0 |
| 2 | 3 | 2 | 1 |
| 3 | 5 | 3 | 1 |
| 4 | 6 | 6 | 3 |
| 5 | 7 | 3 | 1 |
| 6 | 7 | 5 | 3 |
| 7 | 7 | 7 | 3 |
| 8 | 9 | 9 | 3 |
| 9 | 9 | 7 | 5 |

TABLE 4
The fourth MCS table for four allocated streams

| | MCS index | MCS index | MCS index | MCS index |
|---|---|---|---|---|
| | of the | of the | of the | of the |
| MCS set | first | second | third | fourth |
| index | stream | stream | stream | stream |
| 0 | 1 | 1 | 1 | 1 |
| 1 | 3 | 3 | 0 | 0 |
| 2 | 3 | 2 | 1 | 0 |
| 3 | 5 | 3 | 1 | 1 |
| 4 | 6 | 6 | 3 | 2 |
| 5 | 7 | 3 | 1 | 0 |
| 6 | 7 | 5 | 3 | 1 |
| 7 | 7 | 7 | 3 | 0 |
| 8 | 9 | 9 | 3 | 2 |
| 9 | 9 | 7 | 5 | 4 |

In this example, four MCS tables are used (that is, 4≥i≥1), and therefore two bits are required for indicating i. Among the four MCS tables, the maximum number of MCS index sets is 16 (that is, 16≥j≥1), and therefore, four bits are required for indicating j. Thus, in this example, the last two bits, B30 and B31, of the SS allocation/RA-RU information subfield 352 may be used to store i (indicating the number of streams allocated to the STA 112 and the corresponding MCS table), and the four-bit UL MCS subfield 348 may be used to store j (indicating the MCS indices for the allocated streams).

In some embodiments, the encoding of each stream (such as each UL stream) is multi-codeword-based. In other words, the signal transmitted via each stream is encoded and/or interleaved independent of the signals transmitted via other streams. The multi-codeword-based encoding and interleaving may be necessary when different MCS index is allocated to each stream in the DL SU/MU-MIMO transmission as well.

In some embodiments, the combination of the four-bit UL MCS subfield 348 and the two one-bit reserved subfields 350 and 356 (that is, six (6) bits of B21 to B25 and B39) may be used for indicating the MCS index assigned to the receiving STA 112, thereby allowing each MCS table to have a maximum of 64 combinations.

In some embodiments, more bits in the trigger frame 300 may be used for indicating the MCS index assigned to the receiving STA 112, thereby allowing each MCS table to have more combinations. For example, in some embodiments, bits B21 to B25 and B39 (that is, the UL MCS subfield 348 and the two reserved subfields 350 and 356) and one or more bits in the trigger dependent user information subfield 358 may be used for indicating the MCS index assigned to the receiving STA 112.

In some embodiments, one or more of the UL MCS subfield 348, the reserved subfield 350, and the reserved subfield 356 may be used for indicating the MCS index assigned to the receiving STA 112.

In some embodiments, one or more of the UL MCS subfield 348, the reserved subfield 350, and the reserved subfield 356 may be combined with one or more bits in the trigger dependent user information subfield 358 for indicating the MCS index assigned to the receiving STA 112.

In some embodiments, the UL MCS subfield 348 and the two reserved subfields 350 and 356 may not be used for indicating the MCS index assigned to the receiving STA 112. Rather, one or more bits in the trigger dependent user information subfield 358 may be used for indicating the MCS index assigned to the receiving STA 112. In these embodiments, it may be preferable to introduce a new type of trigger frame 300 (for example, denoted “UHR basic trigger frame”) and define necessary information (such as a sub-subfield) in the trigger dependent user information subfield 358.

In above embodiments, in a MCS table for multiple streams (such as Tables 2 to 4 described above), each MCS set comprises the MCS indices for the multiple streams. In some embodiments, in a MCS table for multiple streams, each MCS set may comprise a MCS index (denoted a “base MCS index”) I_{B} of k_{b} bits for a predefined one of the multiple streams (such as for the first stream), and an index difference D of ka bits from the base MCS index for each of other ones of the multiple streams, where 0≤k_{d}≤of k_{b}, such that the MCS index of that stream may be obtained as (I_{B}−D); see Tables 5 to 7. Note that the index differences D for different streams and/or different MCS sets may or may not be the same value.

TABLE 5
MCS table for two allocated streams using MCS index differences

| Stream#: | First stream | Second stream |
|---|---|---|
| MCS set: | Base MCS index | Index difference D of k_{d} |
| | I_{B} of k_{b} bits | bits from base MCS index |
| . . . | . . . | . . . |

TABLE 6
MCS table for three allocated streams using MCS index differences

| Stream#: | First stream | Second stream | Third stream |
|---|---|---|---|
| MCS set: | Base MCS index | Index difference | Index difference |
| | I_{B} of k_{b} bits | D of k_{d} bits from | D of k_{d} bits from |
| | | base MCS index | base MCS index |
| . . . | . . . | . . . | . . . |

TABLE 7
MCS table for four allocated streams using MCS index differences

| Stream#: | First stream | Second stream | Third stream | Fourth stream |
|---|---|---|---|---|
| MCS set: | Base MCS index | Index difference | Index difference | Index difference |
| | I_{B} of k_{b} bits | D of k_{d} bits from | D of k_{d} bits from | D of k_{d} bits from |
| | | base MCS index | base MCS index | base MCS index |
| . . . | . . . | . . . | . . . | . . . |

In some embodiments, in a MCS table for multiple streams, each MCS set may comprise a base MCS index I_{B} of k_{b} bits for a predefined base stream of the multiple streams, and, for each of other ones of the multiple streams, an index difference D of ka bits from a predefined neighboring MCS index, where 0≤k_{d}≤of k_{b}.

For example, as shown in Tables 8 to 10, in a MCS table for multiple streams, the first stream is predefined as the base stream. Each MCS set comprises a base MCS index I_{B} of k_{b} bits for the first stream, and, for each of other ones of the multiple streams, an index difference D of k_{d} bits from the previous MCS index, where 0≤k_{d}≤of k_{b}.

TABLE 8
MCS table for two allocated streams using
neighboring MCS index differences

| Stream#: | First stream | Second stream |
|---|---|---|
| MCS set: | Base MCS index | Index difference D of k_{d} bits |
| | I_{B} of k_{b} bits | from MCS index of first stream |
| . . . | . . . | ... |

TABLE 9
MCS table for three allocated streams
using neighboring MCS index differences

| Stream#: | First stream | Second stream | Third stream |
|---|---|---|---|
| MCS set: | Base MCS index | Index difference | Index difference |
| | I_{B} of k_{b} bits | D of k_{d} bits from | D of k_{d} bits from |
| | | MCS index of | MCS index of |
| | | first stream | second stream |
| . . . | . . . | . . . | . . . |

TABLE 10
MCS table for four allocated streams using neighboring MCS index differences

| Stream#: | First stream | Second stream | Third stream | Fourth stream |
|---|---|---|---|---|
| MCS set: | Base MCS index | Index difference | Index difference | Index difference |
| | I_{B} of k_{b} bits | D of k_{d} bits from | D of k_{d} bits from | D of k_{d} bits from |
| | | MCS index of | MCS index of | MCS index of |
| | | first stream | second stream | third stream |
| . . . | . . . | . . . | . . . | . . . |

In some embodiments, no MCS table is used. In these embodiments, the trigger frame 300 comprises a plurality of MCS indices each for a corresponding allocated stream. For example, the trigger frame 300 may comprise four (4) bits for the MCS index of the first stream, four (4) bits for the MCS of the second stream, four (4) bits for the MCS of the third stream, and four (4) bits for the MCS of the fourth stream. Hence, total 16 bits of UL-MCS sub-field may be required to indicate all MCS index combinations of the streams up to 4 UL streams. The MCS indices may be included in the trigger frame as a plurality of subfields in each user information field 312′, or a plurality of sub-subfields in, for example, the trigger dependent user information subfield 358.

In above embodiments, the MCS tables are defined for each STA with consecutive numbers of streams (that is, one allocated stream, two allocated streams, . . . , L allocated streams), respectively. In some embodiments, the MCS tables are defined for each STA with any suitable numbers of streams not necessarily starting from one allocated stream, and/or not necessarily consecutive numbers of streams. For example, in one embodiment, the MCS tables are defined for each STA with one allocated stream, two allocated streams, and four allocated streams (L=3). In another example, the MCS tables are defined for each STA with two allocated streams, three allocated streams, and four allocated streams (L=3).

In above examples, the last two bits, B30 and B31, of the SS allocation/RA-RU information subfield 352 may be used to store i (indicating the number of streams allocated to the STA 112 and the corresponding MCS table). In some other embodiments, other bits of the SS allocation/RA-RU information subfield 352 may be used to store i (indicating the number of streams allocated to the STA 112 and the corresponding MCS table).

FIG. 8 is a flowchart showing a notification procedure 400 performed by an AP 102 (or more specifically, the at least one processing unit 142 thereof) for notifying a plurality of STAs 112 regarding their allocated streams and corresponding MCS indices. After the procedure 400 starts (step 402), the AP 102 generates a trigger frame 300 with indication of a plurality of streams allocated to each of the STAs 112 and indication of the corresponding MCS indices (step 404). As described above, the trigger frame 300 comprises a user information field 312′ for each STA 112, identified by the unique AID12 subfield 342 of the STA 112. In the user information field 312′ for each STA 112, the last two bits of the SS allocation/RA-RU information subfield 352 are used to indicate the number of streams allocated to the STA 112 and the corresponding MCS table, and the four-bit UL MCS subfield 348 (and/or other subfields/sub-subfields as described above) is used to store j (indicating the MCS indices for the allocated streams).

At step 406, the AP 102 transmits the trigger frame to the plurality of STAs 112. The notification procedure 400 is then ended (step 408).

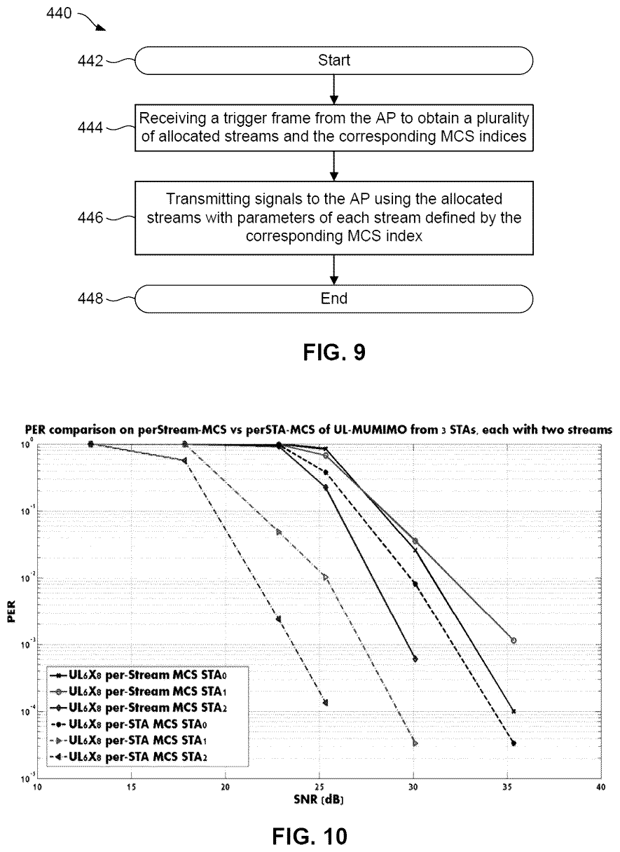

FIG. 9 is a flowchart showing a procedure 440 performed by a STA 112 for establishing the UL communication with the AP 102 using the allocated streams. After the procedure 440 starts (step 442), the STA 112 receives the trigger frame 300 transmitted from the AP 102 as described above to obtain a plurality of allocated streams and the corresponding MCS indices (step 444). More specifically, the STA 112 identifies its user information field 312′ of the trigger frame 300 using its unique AID12, and then obtains the MCS table number (and thus the number of streams allocated to the STA 112) from the last two bits of the SS allocation/RA-RU information subfield 352. The MCS table to be used is then determined. The STA 112 also retrieves the MCS set index from the four-bit UL MCS subfield 348 (and/or other subfields/sub-subfields as described above). The STA then retrieves the MCS indices from the determined MCS table (stored in its memory).

As those skilled in the art understand, each MCS index represents a set of communication parameters. At step 446, the STA 112 transmits signals to the AP 102 using the allocated streams with parameters of each stream defined by the corresponding MCS index. The procedure 440 is then ended (step 448).

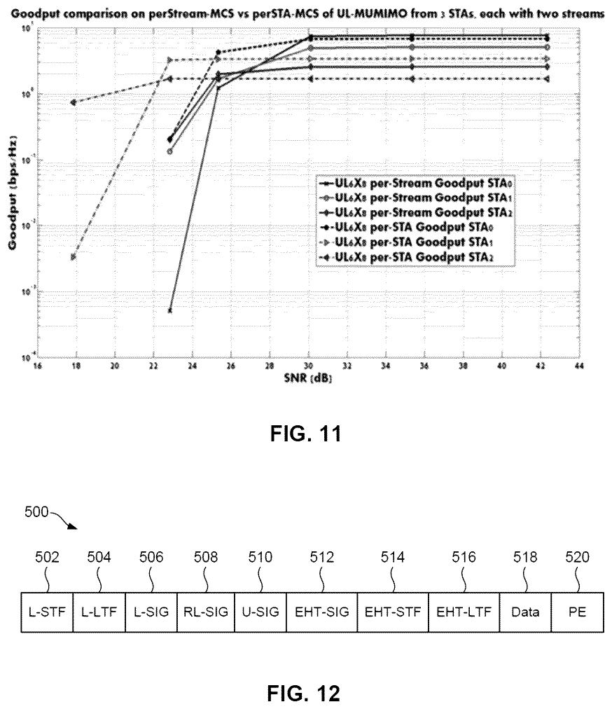

FIGS. 10 and 11 are plots showing some simulation results obtained using the following simulation settings:
6×8 UL MU-MIMO (AP having eight (8) antennas, and three (3) STAs scheduled for UL MU-MIMO, and each STA allocated with two streams (thus, six (6) streams in total));
IEEE high throughput task group (TGn) channel model D for UL;
Per-stream MCS indices:
   STA 0: MCS7-MCS5, STA1: MCS5-MCS3, STA2: MCS3-MCS1;
Per-STA MCS:
   STA 0: MCS5-MCS5, STA1: MCS3-MCS3, STA2: MCS1-MCS1
      Aligned to the worst MCS

Goodput (bps/Hz)=(1−PER)(N_BPSC_A*Coderate_A+N_BPSC_B*Coderate_B)*N_{sc}/OFDM Symbol Length (without Guard Interval)/BW
N_BPSC_A: Number of bits per subcarrier for the first stream
N_BPSC_B: Number of bits per subcarrier for the second stream
Coderate_A: Code rate for the first stream
Coderate_B: Code rate for the second stream
N_{sc}: Total number of data-subcarriers
   BW: Bandwidth
Minimum mean squared error (MMSE) detection is used.

FIG. 10 is a plot showing the PER comparison between per-stream-MCS and per-STA-MCS of UL MU-MIMO from the three (3) STAs, each with two streams.

FIG. 11 is a plot showing the goodput comparison between per-stream-MCS and per-STA-MCS of UL MU-MIMO from the three (3) STAs, each with two streams.

In above embodiments, stream-based MCS allocation methods are used for allocating or otherwise assigning a MCS index to each UL stream of a STA 112. In some embodiments, the trigger frame 300 is used for notifying the STAs the UL streams allocated thereto and the corresponding MCS indices. In some embodiments, the notification or indication of the allocated streams and corresponding MCS indices is embedded in the user information field 312′ for each STA 112. In some embodiments, a plurality of predefined MCS tables are used each comprising a plurality of MCS sets. The number of allocated streams (and accordingly the MCS table number) is stored in the SS allocation/RA-RU information subfield 352 of the STA's user information field 312′, and the MCS set index is stored in the UL MCS subfield 348 and/or other locations of the STA's user information field 312′ (such as the reserved subfield 350, the reserved subfield 356, and/or the trigger dependent user information subfield 358).

In some embodiments, the encoding of each UL stream is multi-codeword-based. In other words, the signal transmitted via each stream is encoded and/or interleaved independent of the signals transmitted via other streams.

In some embodiments, the MCS indices in a MCS set are in descending order as the stream index increases.

In above embodiments, the stream-based MCS allocation and indication methods are used for UL MU-MIMO. In some embodiments, the stream-based MCS allocation and indication methods may be used for UL SU-MIMO.

In some embodiments, the stream-based MCS allocation and indication methods may be used for DL SU-MIMO and/or DL MU-MIMO, wherein the above-described indications of the number of allocated streams and the MCS indices may be stored in the signal (SIG) field (such as the U-SIG or EHT-SIG field) of PPDU.

For example, as shown in FIG. 12, an EHT PPDU 500 comprises the following fields:
L-STF field 502 (a Non-HT short training field);
L-LTF field 504 (a Non-HT long training field);
L-SIG field 506 (a Non-HT signal field);
RL-SIG field 508 (a repeated Non-HT signal field);
U-SIG field 510 (a universal signal field);
EHT-SIG field 512 (an EHT signal field);
EHT-STF field 514 (an EHT short training field);
EHT-LTF field 516 (an EHT long training field);
EHT-Data field 518 (a data field carrying the PSDUs); and
a PE field 520 (a packet extension field).

For MU PPDU, the EHT-SIG field 512 comprises common fields and a plurality of user-specific fields. For SU PPDU, the EHT-SIG field 512 comprises common fields and does not comprise any user-specific fields.

Therefore, in some embodiments, the above-described indications of the number of allocated streams and the MCS indices may be stored in the user-specific fields of the EHT-SIG field 512 of PPDU 500 (for example, for DL MU-MIMO), and/or may be stored in the common fields of the EHT-SIG field 512 of PPDU 500 (for example, for DL SU-MIMO).

In some embodiments, any suitable SIG field or a suitable combination of the SIG fields of PPDU (such as above described PPDU 500 or other types of PPDU) may be used for storing the above-described indications of the number of allocated streams and the MCS indices for DL SU-MIMO and/or DL MU-MIMO.

In these embodiments, the multi-codeword-based encoding and interleaving may be necessary when the MCS index is allocated to each stream in the DL SU/MU-MIMO transmission as well.

The stream-based MCS allocation and indication methods disclosed herein allow APs and STAs to communicate with each other via a plurality of streams with communication parameters (represented by the MCS indices) adapting to the characteristics of the streams for better use of the streams, compared to the conventional methods wherein a STA may have to adapt the worst one of the allocated streams and waste the capacity of other, better streams. As a result, the communication performances achieved by the stream-based MCS allocation and indication methods disclosed herein is improved.

### C. ACRONYM KEY

| | Acronym/Abbreviation/ |
|---|---|
| Full Name | Initialism |
| Access Point | AP |
| Transmitter | TX |
| Receiver | RX |
| Station | STA |
| Up Link | UL |
| Multi User Multiple Input Multiple Output | MU-MIMO |
| Down Link | DL |
| Packet Error Rate | PER |
| Signal to Noise Ratio | SNR |
| Beamforming | BF |
| Iterative UL BF | ITULBF |
| Modulation and Coding System | MCS |
| High Efficiency | HE |
| Extremely High Throughput | EHT |
| Medium Access Control Layer | MAC |
| Receiver Address | RA |
| Transmitter Address | TA |
| Frame Check Sum | FCS |
| Forward Error Correction | FEC |
| Ultra High Reliability | UHR |
| Spatial Stream | SS |
| Random Access Resource Unit | RA-RU |
| Association Identification | AID |
| International Electrical and Electronic | IEEE |
| Engineering | |
| Minimum Mean Squared Error | MMSE |
| Orthogonal Frequency Division Multiplexing | OFDM |

Although embodiments have been described above with reference to the accompanying drawings, those of skill in the art will appreciate that variations and modifications may be made without departing from the scope thereof as defined by the appended claims.

What is claimed is:

1. A method comprising:
generating signaling for one or more devices; and
transmitting the signaling to the one or more devices;
wherein, for each of the one or more devices, the signaling indicates a plurality of streams allocated to the device and a plurality of modulation and coding system (MCS) indices each corresponding to one of the plurality of streams.

2. The method of claim 1, wherein the signaling comprises a first indication and a second indication for each of one or more devices; and
wherein, for each of the one or more devices, the first indication indicates a plurality of streams allocated to the device, and the second indication indicates a plurality of modulation and coding system (MCS) indices each corresponding to one of the plurality of streams.

3. The method of claim 2, wherein the first indication also indicates an MCS table comprising a plurality of MCS sets, each MCS set comprising a plurality of items representing a plurality of candidate MCS indices for the plurality of streams, and the second indication comprises a MCS set index for indicating one MCS set of the plurality of MCS sets.

4. The method of claim 3, wherein the MCS table is one of a plurality of candidate MCS tables;
wherein the plurality of candidate MCS tables comprise a single-stream MCS table; and
wherein each MCS set of the single-stream MCS table comprises a respective MCS index excluding a MCS index of a Dup mode.

5. The method of claim 3, wherein the MCS table is one of a plurality of candidate MCS tables,
wherein the plurality of candidate MCS tables comprises at least one of:
a two-stream MCS table, wherein each MCS set of the two-stream MCS table comprises a respective MCS index; or
a three-stream MCS table, wherein each MCS set of the three-stream MCS table comprises a respective MCS index; or
a four-stream MCS table, wherein each MCS set of the four-stream MCS table comprises a respective MCS index.

6. The method of claim 5, wherein the plurality of candidate MCS indices of each MCS set are in non-ascending or descending order with indices of the plurality of streams increasing.

7. The method of claim 5, wherein the plurality of items of each MCS set are the plurality of candidate MCS indices of the MCS set;
wherein the plurality of items of each MCS set comprises a base candidate MCS index and one or more indexes different from the base candidate MCS index; or
wherein the plurality of items of each MCS set comprises a base candidate MCS index and one or more indexes different from a neighboring candidate MCS index thereof.

8. The method of claim 2, wherein the second indication comprises a plurality of candidate MCS indices.

9. The method of claim 2, wherein the signaling is carried in a physical layer protocol data unit (PPDU) for downlink (DL) MIMO communication; and
wherein the first and second indications for each device are carried in one or more signal (SIG) fields of the PPDU.

10. The method of claim 9, wherein the one or more SIG fields of the PPDU comprise one or more of a legacy signal (L-SIG) field, a repeated legacy signal (RL-SIG) field, a universal signal (U-SIG) field, and an extremely high throughput signal (EHT-SIG) field.

11. The method of claim 9, wherein the one or more SIG fields of the PPDU comprise an extremely high throughput signal (EHT-SIG) field; and
wherein the first and second indications for each device are carried in one or more user-specific fields of the EHT-SIG field for downlink (DL) multiple user-multiple input multiple output (MU-MIMO), or in one or more common fields of the EHT-SIG field for DL single user-multiple input multiple output (SU-MIMO).

12. A method comprising:
receiving signaling from a device to obtain a plurality of streams and a plurality of modulation and coding system (MCS) indices corresponding to the plurality of streams; and
communicating with the device using the plurality of streams with parameters of each stream defined by the corresponding one of the plurality of MCS indices.

13. The method of claim 12, wherein the method is performed by a station (STA).

14. The method of claim 12, wherein the device is an access point (AP).

15. The method of claim 12, wherein the signaling comprises a first indication indicating the plurality of streams, and a second indication indicating the plurality of MCS indices.

16. The method of claim 15, wherein the first indication also indicates an MCS table comprising a plurality of MCS sets, each MCS set comprises a plurality of items representing a plurality of candidate MCS indices for the plurality of streams, and the second indication comprises an MCS set index for indicating one MCS set of the plurality of MCS sets.

17. The method of claim 16, wherein the MCS table is one of a plurality of candidate MCS tables;
wherein the plurality of candidate MCS tables comprise a single-stream MCS table; and
wherein each MCS set of the single-stream MCS table comprises a respective MCS index excluding a MCS index of a Dup mode.

18. The method of claim 16, wherein the MCS table is one of a plurality of candidate MCS tables, and
wherein the plurality of candidate MCS tables comprises at least one of:
a two-stream MCS table, wherein each MCS set of the two-stream MCS table comprises a respective MCS index; or
a three-stream MCS table, wherein each MCS set of the three-stream MCS table comprises a respective MCS index; or
a four-stream MCS table, wherein each MCS set of the four-stream MCS table comprises a respective MCS index.

19. The method of claim 18, wherein the plurality of candidate MCS indices of each MCS set are in non-ascending or descending order with indices of the plurality of streams increasing.

20. The method of claim 18, wherein the plurality of items of each MCS set are the plurality of candidate MCS indices of the MCS set;
wherein the plurality of items of each MCS set comprises a base candidate MCS index and one or more index different from the base candidate MCS index; or
wherein the plurality of items of each MCS set comprises a base candidate MCS index and one or more index different from a neighboring candidate MCS index thereof.
